(19) United States
(12) Patent Application Publication
(10) Pub. No.: US 2025/0148542 A1
(43) Pub. Date: May 8, 2025

(54) ARTIFICIAL INTELLIGENCE (AI) ASSISTED DECISION SUPPORT SYSTEM AND RELATED METHODS AND COMPUTER PROGRAM PRODUCTS

(71) Applicant: Optum, Inc., Minnetonka, MN (US)

(72) Inventors: Vijaychandar Natesan, Bangalore (IN); Pawan Kumar Pandey, Bengaluru (IN); Ramesh R. Ganesan, Bangalore (IN); Rakesh P A, Bangaluru (IN); Jason Glackin, Derry (GB); Maureen E. Calkins, Hamburg, NY (US); Bruce E. Thompson, Dallas, TX (US); Christina Lynn Jay, Eau Claire, WI (US); Jerelyn P P, Chaennai (IN); Vishal Gupta, Bengaluru (IN); Bakya Sri V, Trichy (IN); Shivangi Priyadarshini, Bangalore (IN); Lila R. Muhammed, Ellsinore, MO (US); Tejaswi P, Bangalore (IN); Guntupalli Sumanth Naga Deep, Krishna (IN); Prabhu Vincent, Bangalore (IN); Chethan Rai, Bangalore (IN); Srijan Agrawal, Indore (IN)

(21) Appl. No.: 18/898,974

(22) Filed: Sep. 27, 2024

Related U.S. Application Data
(60) Provisional application No. 63/586,122, filed on Sep. 28, 2023.

(51) Int. Cl. G06Q 40/08; G06F 8/30; G06F 9/54

(52) U.S. Cl. CPC G06Q 40/08; G06F 8/30; G06F 9/54

(57) ABSTRACT

A computer-implemented method includes receiving, by one or more processors, Process Instruction (PI) information containing instructions for adjudicating a healthcare service request based on a primary fact source; dividing, by the one or more processors and using an Artificial Intelligence (AI) model, the instructions into one or more instruction sets; generating, by the one or more processors and the AI model, an input-output mapping for first ones of the one or more instruction sets having a complexity that does not satisfy a complexity threshold; generating, by the one or more processors and the AI model, code for second ones of the one or more instructions sets having the complexity that satisfies the complexity threshold; generating, by the one or more processors and the AI model, a validation input set for the input-output mapping and for the code; and applying, by the one or more processors and the AI model, the validation input set to the input-output mapping and the code to generate a validation output for the input-output mapping and for the code.

### CROSS-REFERENCE TO RELATED APPLICATION

The present application claims priority to U.S. Provisional Patent Application Ser. No. 63/586,122, filed Sep. 28, 2023, the entire content of which is incorporated by reference herein as if set forth in its entirety

### FIELD

The present disclosure relates generally to decision support systems and services.

### BACKGROUND

Many traditional (e.g., non-generative) artificial intelligence technologies generate predictions based on measuring statistical importance of features in view of historical data. However, the reliance on statistical operations by these machine learning technologies in some cases limits their applicability because statistical operations and output predictions are not easily explainable. Recently, generative artificial intelligence models such as Large Language Models (LLMs) have been developed where at least the output of such models can be easily explainable given the nature of LLMs receiving a text prompt and outputting a text response message.

Typically, traditional artificial intelligence technologies and generative artificial intelligence technologies operate independently. Accordingly, there are opportunities to further develop systems where such technologies may co-exist and/or work together.

### SUMMARY

According to some embodiments of the disclosure, a computer-implemented method comprises: receiving, by one or more processors, Process Instruction (PI) information containing instructions for adjudicating a healthcare service request based on a primary fact source; dividing, by the one or more processors and using an Artificial Intelligence (AI) model, the instructions into one or more instruction sets; generating, by the one or more processors and the AI model, an input-output mapping for first ones of the one or more instruction sets having a complexity that does not satisfy a complexity threshold; generating, by the one or more processors and the AI model, code for second ones of the one or more instructions sets having the complexity that satisfies the complexity threshold; generating, by the one or more processors and the AI model, a validation input set for the input-output mapping and for the code; and applying, by the one or more processors and the AI model, the validation input set to the input-output mapping and the code to generate a validation output for the input-output mapping and for the code.

In other embodiments, the method further comprises: when the one or more instruction sets reference access to one or more facts not included in the primary fact source, selecting, by the one or more processors and the AI model, one or more Application Programming Interfaces (APIs) for one or more secondary fact sources from an API library for accessing the one or more facts; and inserting, by the one or more processors and the AI model, the selected one or more APIs as API calls into the code.

In still other embodiments, the method further comprises: when the one or more instruction sets reference access to one or more facts not included in the primary fact source and an Application Programming Interface (API) for a secondary fact source for accessing the one or more facts does not exist in an API library, generating, by the one or more processors and the AI model, an API for the secondary fact source for accessing the one or more facts, the API for the secondary fact source including an API description, inputs to the API, and expected outputs from the API.

In still other embodiments, generating the code comprises: extracting, by the one or more processors and the AI model, elements of the second ones of the one or more instructions sets into a structured format; generating, by the one or more processors and the AI model, one or more prompts from the elements in the structured format; and generating, by the one or more processors and the AI model, code for the second ones of the one or more instructions sets based on the one or more prompts.

In still other embodiments, the structured format is Hypertext Markup Language (HTML) or Javascript Object Notation (JSON).

In still other embodiments, the PI information is current PI information and AI model is a first AI model, the method further comprising: determining, by the one or more processors and a second AI model, whether the current PI information has been modified relative to previous PI information; and when the current PI information has been modified, performing, by the one or more processors and the first AI model, dividing the instructions, generating the input-output mapping, generating the code, generating the validation input set, and applying the validation input set.

In still other embodiments, determining, by the one or more processors and the second AI model, whether the current PI information has been modified comprises: generating, by the one or more processors and the second AI model, first embedding vectors for the current PI information instructions; generating, by the one or more processors and the second AI model, second embedding vectors for previous PI information instructions; and determining, by the one or more processors and the second AI model, similarities between the first embedding vectors and the second embedding vectors.

In still other embodiments, determining the similarities comprises: determining, by the one or more processors and the second AI model, a set of logits corresponding to a set of inner products between ones of the first embedding vectors and ones of the second embedding vectors.

In still other embodiments, determining the similarities further comprises: applying, by the one or more processors and the second AI model, a sigmoid function to each of the set of logits to generate a set of similarity probabilities.

In still other embodiments, determining whether the current PI information has been modified comprises: comparing, by the one or more processors and the second AI model, each of the set of similarity probabilities to a similarity threshold to generate a set of similarity comparison results; and determining, by the one or more processors and the second AI model, whether the current PI information has been modified based on the set of similarity comparison results.

In still other embodiments, the complexity is based on grammar elements in sentences of the PI information instructions.

In still other embodiments, the primary fact source is a health insurance claim, the decision is a denial of payment of the health insurance claim by a payor, and the PI information is associated with the payor.

In still other embodiments, the AI model is a large language model.

In still other embodiments, wherein receiving, the PI information containing instructions for adjudicating the healthcare service request based on the primary fact source comprises: converting, by the one or more processors, the PI information into Hypertext Markup Language (HTML) format; receiving, by the one or more processors, input from a user that interprets a portion of the HTML converted PI information; displaying, by the one or more processors and the AI model, proposed instructions to the user based on the input from the user and the HTML converted PI information; and iteratively performing, by the one or more processors and the AI model, the receiving input from the user and displaying the proposed instructions to the user until receiving approval from the user of the proposed instructions as the instructions for adjudicating the healthcare service request.

In still other embodiments, generating the code for the second ones of the one or more instructions sets having the complexity that satisfies the complexity threshold, comprises: generating, by the one or more processors and the AI model, the code for the second ones of the one or more instructions sets having the complexity that satisfies the complexity threshold using an agentic workflow.

In some embodiments of the disclosure, a computer-implemented method comprises: receiving, by one or more processors, a primary fact source and a request to adjudicate a decision related to a healthcare service request based on the primary fact source; automatically processing, by the one or more processors, the request and the primary fact source using a Decision Support System (DSS), the DSS comprising an Artificial Intelligence (AI) model generated input-output mapping for first ones of one or more instructions sets of Process Instruction (PI) information for adjudicating the decision and code for second ones of the one or more instruction sets of the PI information, the code including one or more Application Programming Interface (API) calls to one or more secondary fact sources for accessing one or more facts not included in the primary fact source; generating, by the one or more processors and the DSS, a recommendation whether to maintain the decision; and identifying, by the one or more processors and the AI model, one or more relevant facts from the primary fact source or the one or more secondary fact sources and one or more relevant instructions from the PI information instruction sets used in generating the recommendation.

In further embodiments, automatically processing the request and the primary fact source comprises: selecting, by the one or more processors, the input-output mapping or the code for performing the processing one or more portions of the request or the primary fact source based on the request and the primary fact source.

In still further embodiments, the primary fact source is a health insurance claim, the decision is a denial of payment of the health insurance claim by a payor, and the PI information is associated with the payor.

In still further embodiments, the AI model is a large language model.

In some embodiments of the disclosure, a system, comprises one or more processors; and at least one memory storing computer readable program code that is executable by the one or more processors to perform operations comprising: receiving Process Instruction (PI) information containing instructions for adjudicating a healthcare service request based on a primary fact source; dividing, by an Artificial Intelligence (AI) model, the instructions into one or more instruction sets; generating, by the AI model, an input-output mapping for first ones of the one or more instruction sets having a complexity that does not satisfy a complexity threshold; generating, by the AI model, code for second ones of the one or more instructions sets having the complexity that satisfies the complexity threshold; generating, by the AI model, a validation input set for the input-output mapping and for the code; and applying, by the AI model, the validation input set to the input-output mapping and the code to generate a validation output for the input-output mapping and for the code.

In other embodiments, the operations further comprise: when the one or more instruction sets reference access to one or more facts not included in the primary fact source, selecting, by the one or more processors and the AI model, one or more Application Programming Interfaces (APIs) for one or more secondary fact sources from an API library for accessing the one or more facts; and inserting, by the one or more processors and the AI model, the selected one or more APIs as API calls into the code.

In some embodiments of the disclosure, one or more non-transitory computer readable storage media comprising computer readable program code stored in the media that is executable by one or more processors to perform operations comprising: receiving Process Instruction (PI) information containing instructions for adjudicating a healthcare service request based on a primary fact source; dividing, by an Artificial Intelligence (AI) model, the instructions into one or more instruction sets; generating, by the AI model, an input-output mapping for first ones of the one or more instruction sets having a complexity that does not satisfy a complexity threshold; generating, by the AI model, code for second ones of the one or more instructions sets having the complexity that satisfies the complexity threshold; generating, by the AI model, a validation input set for the input-output mapping and for the code; and applying, by the AI model, the validation input set to the input-output mapping and the code to generate a validation output for the input-output mapping and for the code.

In some embodiments of the disclosure a computer-implemented method comprises: receiving, by one or more processors via a first machine learning model, a prompt configured to instruct the first machine learning model to parse text input into the first machine learning model; determining, by the one or more processors via the first machine learning model, that at least a portion of the parsed text input maps to an application programming interface (API) among a set of APIs identified by a second machine learning model; generating, by the one or more processors via the first machine learning model, a response message based on the prompt and the API; and establishing, by the one or more processors and based on the generated response message, a communication session with a data source via the API

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the disclosure will be or become apparent to one with skill in the art upon review of the following drawings and detailed description. It is intended that all such additional systems, methods, articles of manufacture, and/or computer program products be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including an Artificial Intelligence (AI) assisted decision support system for adjudicating health care service requests in accordance with some embodiments of the disclosure;

FIG. 2 is a block diagram that illustrates the AI assisted decision support system for adjudicating health care service requests in accordance with some embodiments of the disclosure;

FIG. 3 is a block diagram of a health care service request adjudication large language model in accordance with some embodiments of the disclosure;

FIG. 4 is a flowchart that illustrates operation of the AI assisted decision support system for adjudicating health care service requests in accordance with some embodiments of the disclosure;

FIG. 5 is a block diagram of a process instruction modification detection system in accordance with some embodiments of the disclosure;

FIG. 6 is a flowchart that illustrates further operations of the AI assisted decision support system for adjudicating health care service requests in accordance with some embodiments of the disclosure;

FIG. 7 is a graph that illustrates generation of an inner product between two vectors;

FIG. 8 is an example of a prompt used by the AI assisted decision support system for generating code in accordance with some embodiments of the disclosure;

FIG. 9 is a flowchart that illustrates further operations of the AI assisted decision support system for adjudicating health care service requests in accordance with some embodiments of the disclosure;

FIG. 10 is a data processing system that may be used to implement an AI assisted decision support system for adjudicating health care service requests in accordance with some embodiments of the disclosure;

FIG. 11 is a block diagram that illustrates a software/hardware architecture for use in an AI assisted decision support system for adjudicating health care service requests in accordance with some embodiments of the disclosure;

FIG. 12 is a flowchart that illustrates further operations of the AI assisted decision support system for adjudicating health care service requests in accordance with some embodiments of the disclosure; and

FIG. 13 is an agentic workflow diagram that illustrates further operations of the AI assisted decision support system for adjudicating health care service requests in accordance with some embodiments of the disclosure.

### DETAILED DESCRIPTION

In the following detailed description, numerous specific details are set forth to provide a thorough understanding of embodiments of the disclosure. However, it will be understood by those skilled in the art that embodiments of the disclosure may be practiced without these specific details. In some instances, well-known methods, procedures, components, and circuits have not been described in detail so as not to obscure the disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, the term “provider” may mean any person or entity involved in providing health care products and/or services to a patient.

Embodiments of the disclosure are described herein in the context of an Artificial Intelligence (AI) assisted decision support system for adjudicating appeals of health insurance claim denials by payors. It will be understood, however, that embodiments of the disclosure are applicable generally to adjudicating an appeal of a decision based on a primary fact source. Further, embodiments of the disclosure are applicable generally to adjudicating healthcare service requests including, but not limited to, enrollment applications, appeals of claim denials or other type of denial, claim processing, provider contract loads, and the like. The AI model of the AI assisted decision support system for adjudicating appeals of decisions may be embodied in a variety of different ways including, but not limited to, one or more of the following AI systems: a multi-layer neural network, a machine learning system, a deep learning system, a large language model, a natural language processing system, and/or computer vision system. Moreover, it will be understood that the multi-layer neural network is a multi-layer artificial neural network comprising artificial neurons or nodes and does not include a biological neural network comprising real biological neurons. The AI models described herein may be configured to transform a memory of a computer system to include one or more data structures, such as, but not limited to, arrays, extensible arrays, linked lists, binary trees, balanced trees, heaps, stacks, and/or queues. These data structures can be configured or modified through the adjudication process and/or the AI training process to improve the efficiency of a computer system when the computer system operates in an inference mode to make an inference, prediction, classification, suggestion, or the like with respect to adjudicating an appeal of a decision based on a primary fact source.

Health care service providers have patients that pay for their care using a variety of different payors. For example, a medical facility or practice may serve patients that pay by way of different insurance companies including, but not limited to, private insurance plans, government insurance plans, such as Medicare, Medicaid, and state or federal public employee insurance plans, and/or hybrid insurance plans, such as those that are sold through the Affordable Care Act. When providers and/or patients submit claims to the payors for payment, the claims can be denied in whole or in part for a variety of different reasons including, but not limited to, incorrect data in the claim, such as the wrong name for the patient or billing code medical coding errors, medical necessity, cost control, e.g., a less expensive option must be tried first, the service or product is not covered under the insurance plan's terms, the provider is not part of the insurance plan's network, the claim has missing details or attachments, the insurance plan's rules were not followed, e.g., pre-authorization is required, but not obtained. When a provider and/or patient receives notice that a payor has denied payment in whole or in part for a claim, the provider and/or patient may choose to appeal the payor's decision to deny payment, which may include an updated claim with revised and/or supplemental information, and may further include arguments explaining why the provider and/or patient believe the claim was improperly denied.

Upon receiving an appeal of a claim that has been denied in whole or in part, a payor will typically have the appeal entered into an appeal tracking system for tracking the status of the appeal during the reconsideration process. A payor may have a set of guidelines and regulations for processing the appeal, which may be known as Process Instructions (PI). One or more persons tasked with adjudicating the appeal may manually review the appeal documentation, including the claim and claim attachments, along with the PI documentation. In addition, the person(s) processing the appeal may reach out to one or more internal and/or external sources for information that may be pertinent to processing the appeal. For example, the provider may be contacted to obtain information from the patient's medical record, an internal eligibility system may be contacted to obtain details on a patient's eligibility and coverage under one or more plans, and/or the Center for Medicare and Medicaid Services (CMS) may be contacted to obtain information on their guidelines. After applying the rules set forth in the PI document to the claim including any supplemental information obtained from internal and/or external sources, the person(s) in charge of adjudicating the appeal may communicate an appeal decision to the provider and/or patient. This largely manual process to adjudicate an appeal of a denied claim may be time consuming and expensive for the payor.

Some embodiments of the disclosure stem from a realization that when a payor adjudicates an appeal of a denied health care claim, the operations associated with reviewing the denied claim, obtaining facts from the claim, any attachments to the claim, and other sources, such as a provider, internal payor systems, and the like, reviewing a Process Instructions (PI) document that contains rules and other instructions for adjudicating the claim, and reaching a decision on whether to maintain the decision to deny the claim or approve the claim is largely a manual process. This manual process may be time consuming and expensive for a payor and may result in inconsistent appeals decisions due to persons interpreting the PI information and how it applies to the facts differently. Some embodiments of the disclosure may provide an Artificial Intelligence (AI) assisted decision support system that may be used to assist a payor in adjudicating health care claim appeals. The AI assisted decision support system may receive a PI document and may divide the PI document into various components, such as the instruction sets, e.g., rules, the identities of internal and external systems that are accessed to obtain facts, any links to other process instructions, and outcomes based on the various instructions and facts. The AI assisted decision support system may include an appeal adjudication large language model that may automatically generate input-output mappings or code based on the complexity of the instructions obtained from the PI document. These input-output mappings and code may be executable on a computer to automate the application of the PI instructions to the facts surrounding the appeal. By generating input-output mappings for less complex PI instructions and generating code for more complex PI instructions, the effective execution of the PI instructions on a computer can be performed more efficiently as code is generally more processor resource intensive than the input-output mappings. The claim and any attachments may serve as a primary fact source, but various secondary fact sources may be accessed to obtain other facts that are pertinent in adjudicating the appeal. The appeal adjudication large language model may insert API calls or references to APIs into the generated code that may be used to access these secondary fact sources to obtain the needed facts for adjudicating the appeal. In some embodiments, the reference to an API may be interpreted at run time and an API call generated to access the appropriate secondary fact source.

To ensure that the automatically generated input-output mappings and code accurately reflect the logic contained in the PI instructions, the appeal adjudication large language model may generate a validation input set that includes all possible inputs for validating the each of the PI instructions as represented in the input-output mapping and the code. The validation input set can be applied to the input-output mapping and the code to ensure that the input-output mapping and the code accurately reflect the logic contained in the PI instructions. By validating the accuracy of the input-output mapping and the code before the input-output mappings and code are used to adjudicate an appeal, the accuracy of the recommendation output from the AI assisted decision support system may be improved and the need to correct errors in the input-output mapping and/or code and adjudicate an appeal multiple times may be reduced thereby saving processor and other computing resources.

The appeal adjudication large language model may be used to generate input-output mappings and code for PI instruction documents associated with a variety of different payors. The appeal adjudication large language model need not be re-trained to process a PI document for a new payor or when a payor makes modifications to an existing PI document. Computing resources, therefore, need not be devoted to retraining the appeal adjudication large language model each time a new payor or other entity provides PI instructions for using the AI assisted decision support system for adjudicating an appeal. In some embodiments, the AI assisted decision support system may make use of a PI modification detection system that can detect, for example, whether a current PI document for a payor is modified relative to a previous PI document. When a modification is detected, then the input-output mapping and/or code may be updated to reflect the changes to the PI document. Otherwise, the existing input-output mapping and code that has been previously generated can be used to process a new appeal for a claim denial associated with that payor. In some embodiments, the appeal adjudication large language model need only generate input-output mappings and/or code for the new or modified portions of the PI document when input-output mappings and/or code have already been generated for a previous version of the PI document.

When the input-output mapping and code are executed to generate a recommendation on whether to maintain a denial of a claim or to overturn the denial and sustain the appeal, the appeal adjudication large language model may identify one or more of the PI instructions and/or one or more facts used in making the recommendation that had the most significant impacts in reaching the recommendation. This may allow an auditor to manually review the PI information including the identified instruction(s) and facts to verify that the recommendation is based on sound reasoning. The audit capability may provide a payor with more confidence that the PI instructions are correct, and they are being interpreted correctly by the appeal adjudication large language model in the input-output mapping and code generation process. In some instances, a payor may choose to automatically accept the appeal decision recommendation. For example, a payor may automatically choose to accept the appeal decision recommendation for claims below a certain value threshold or when the recommendation is to approve payment of the claim.

Although embodiments of the disclosure are described above by way of example with respect to adjudicating an appeal of a claim denial associated with a payor, embodiments of the disclosure are applicable to adjudicating a decision generally and may include, for example, adjudication of healthcare care service requests, such as, but not limited to, enrollment applications, claims processing, appeal request, provider contract load, etc.

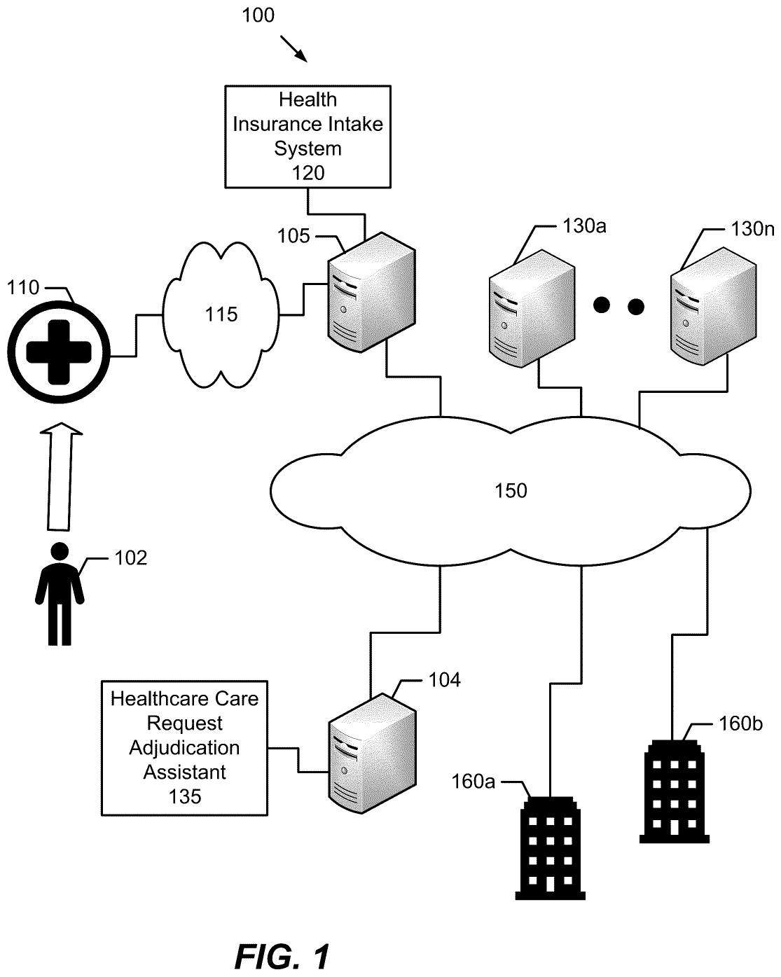

Referring to FIG. 1, a communication network 100 including an AI assisted decision support system for adjudicating an appeal of a decision, such as a denial of a health care claim by a payor, in accordance with some embodiments of the disclosure, comprises one or more health care provider facilities or practices 110 that treats one or more patients 102. Each health care provider facility or practice may represent various types of organizations that are used to deliver health care services to patients via health care professionals, which are referred to generally herein as “providers.” The providers may include, but are not limited to, hospitals, medical practices, mobile patient care facilities, diagnostic centers, lab centers, pharmacies, and the like. The providers may operate by providing health care services for patients and then invoicing one or more payors 160a and 160b for the services rendered. The payors 160a and 160b may include, but are not limited to, providers of private insurance plans, providers of government insurance plans (e.g., Medicare, Medicaid, state, or federal public employee insurance plans), providers of hybrid insurance plans (e.g., Affordable Care Act plans), providers of private medical cost sharing plans, and the patients themselves. One provider facility 110 is illustrated in FIG. 1 with the provider including a patient intake/accounting system server 105 accessible via a network 115. The patient intake/accounting system server 105 may be configured with a health insurance intake system module 120 to manage the intake of patients for appointments and to generate invoices for payors for services and products rendered through the provider 110. The network 115 communicatively couples the patient intake/accounting system server 105 to other devices, terminals, and systems in the provider's facility 110. The network 115 may comprise one or more local or wireless networks to communicate with patient intake/accounting system server 105 when the patient intake/accounting system server 105 is located in or proximate to the dental care service provider facility 110. When the patient intake/accounting system server 105 is in a remote location from the health care facility, such as part of a cloud computing system or at a central computing center, then the network 115 may include one or more wide area or global networks, such as the Internet.

According to some embodiments of the disclosure, a healthcare care request adjudication assistant server 104 may include a healthcare care request adjudication assistant module 135 that is configured to provide one or more AI models. The one or more AI models are configured to receive PI information, such as a PI document provided by a payor 160a, 160b, which contains instructions for adjudicating an appeal of a decision, such as a denial of a health care claim by a payor 160a, 160b or adjudication of other type of healthcare care request. The PI information may be processed and segregated to extract different types of information therefrom, such as instruction sets, identities of internal and external systems for obtaining facts, links to other sources of instructions, and outcomes based on the instructions and facts. The healthcare care request adjudication assistant 135 may include an appeal adjudication large language model that may be configured to automatically generate input-output mappings or code based on the complexity of the instructions obtained from the PI document. In addition to obtaining facts from, for example, a primary fact source, such as a health care claim, including attachments, being appealed along with the appeal request, additional facts may be needed to adjudicate the appeal decision. These additional facts may be obtained from secondary fact sources 130a, . . . 130n. These secondary fact sources may be internal or external systems to, for example, a payor 160a, 160b or other entity adjudicating an appeal of a decision. The appeal adjudication large language model may insert API calls or references to APIs into the generated code that may be used to access these secondary fact sources 130a, . . . 130n to obtain the needed facts for adjudicating the appeal. In some embodiments, the reference to an API may be interpreted at run time and an API call generated to access the appropriate secondary fact source 130a, . . . 130n. The input-output mapping and code may be executed by a computer to generate a recommendation on whether to maintain a decision, such as a denial of a claim, or to overturn the decision and sustain the appeal. To provide insight into what deficiencies may still be present in the appeal request or to highlight why the previous decision was overturned, the appeal adjudication large language model may identify one or more of the PI instructions and/or one or more facts used in making the recommendation that had the most significant impacts in reaching the recommendation. This insight may assist in auditing the recommendation output from the appeal adjudication large language model to ensure that the generated recommendation correctly adheres to the logic provided in the PI instructions.

A network 150 couples the patient intake/accounting system server 105 and payors 160a, 160b to the healthcare care request adjudication assistant server 104. The network 150 may be a global network, such as the Internet or other publicly accessible network. Various elements of the network 150 may be interconnected by a wide area network, a local area network, an Intranet, and/or other private network, which may not be accessible by the general public. Thus, the communication network 150 may represent a combination of public and private networks or a virtual private network (VPN). The network 150 may be a wireless network, a wireline network, or may be a combination of both wireless and wireline networks.

The decision support system service for adjudicating appeal decisions provided through the healthcare care request adjudication assistant server 104 may, in some embodiments, be embodied as a cloud service. For example, health care service providers 110 and/or payors 160a, 160b may access the decision support system service for adjudicating healthcare service requests as a Web service. In some embodiments, the decision support system service for adjudicating appeals may be implemented as a Representational State Transfer Web Service (RESTful Web service).

Although FIG. 1 illustrates an example communication network including an AI assisted decision support system for adjudicating healthcare service requests, it will be understood that embodiments of the inventive subject matter are not limited to such configurations, but are intended to encompass any configuration capable of carrying out the operations described herein.

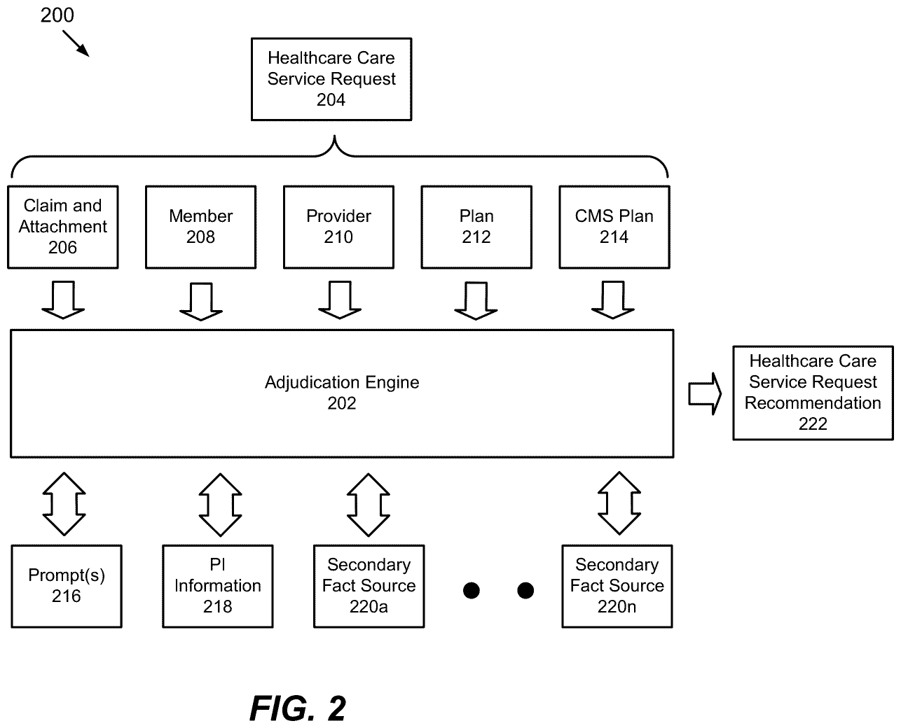

FIG. 2 is a block diagram that illustrates an AI assisted decision support system 200 for adjudicating health care claim appeals that may be embodied using the healthcare care request adjudication assistant server 104 and healthcare care request adjudication assistant module 135 of FIG. 1 in accordance with some embodiments of the disclosure. As shown in FIG. 2, the AI assisted decision support system 200 include an adjudication engine 202 that is configured to receive and process information from a healthcare care service request 204, such as an enrollment application, claim processing request, appeal request, a provider contract load, or the like. The appeal request may, for example, include a health care claim that has been denied by a payor 160a, 160b including any attachments. The adjudication engine 202 may extract various facts and other information items from the appeal request and claim, such as the claim and any attachment(s) 206, information about the member 208, e.g., patient, such as name and other demographic information, information about the health care provider 210, such as name, practice specialty, and other demographic information, an identification of the insurance plan 212 that the member 208 is enrolled in, and/or an identification of the Medicare or Medicaid plan 214 that the member is enrolled in. The adjudication engine 202 may, therefore, use the appeal request, claim, and any attachments as a primary fact source in adjudicating the appeal decision. As described above, an appeal adjudication large language model may be used to generate input-output mappings and code based on PI information 218, such as a PI document associated with a payor that contains instructions for adjudicating an appeal of a denial of a health care claim. Thus, the adjudication engine 202 may include an appeal adjudication large language model that operates in response to one or more prompts 216 to automatically generate input-output mappings and/or code for PI information 218. In some embodiments, the PI information 218 can be generated by applying an intelligent parser and/or a language model to documented Standard Operating Procedures (SOP). Further, subject matter experts and/or a trained AI based subject matter expert on the standard operating procedures may be applied to the PI information 218 to provide feedback for refining the PI information 218 (e.g., correct errors, provide additional detail, and the like) before the appeal adjudication large language model is used to generate the input-output mappings and code, including API calls and/or API references, based on the PI information 218.

While the appeal request, claim, and attachments may serve as a primary source of facts in adjudicating the appeal decision, the PI information 218 instructions may use additional facts in adjudicating the appeal decision that are available from secondary fact sources 220a, . . . , 220n. These secondary fact sources may be, for example, internal payor systems that verify whether the member 208 is eligible for coverage and the details on the specific plan in which the member is enrolled, or external systems, such as those provided by the Center for Medicare and Medicaid Services (CMS) to verify any coverage provided by a public plan and how it may work in conjunction with a private plan. As described above, API calls and/or API references, which are converted to API calls at run time may be inserted into the code for accessing these secondary fact sources. These secondary fact sources may, in some embodiments, use AI resources, such as, but not limited to, machine learning, deep learning, neural networks, natural language processing, large language models, and the like. These AI resources may base based on probabilistic and/or deterministic models. For example, an instruction in a PI document may require that the claim include as an attachment an MRI of a particular body area. The attachment from the claim may be communicated to a secondary fact source 220a, . . . , 220n, which may use an AI model to evaluate the attachment to verify whether or not the attachment is an MRI of the correct body area. The adjudication engine 202 may execute the input-output mappings and/or the code generated by the appeal adjudication large language model on a computer to process the appeal request, claim, and any attachments along with any facts obtained from the secondary fact sources 220a, . . . , 220n to generate a healthcare care service request recommendation 222. As described above, the appeal adjudication large language model may identify one or more of the PI instructions and/or one or more facts used in making the recommendation that had the most significant impacts in reaching the healthcare care service request recommendation 222. The appeal adjudication large language model may, in some embodiments, be trained based on historical PI information by one or more processors of a first computing entity that is used to execute the appeal adjudication large language model in inference mode. In other embodiments, the appeal adjudication large language model may be trained by one or more processors on a second computing entity that is not used to execute appeal adjudication large language model in inference mode.

The appeal adjudication large language model of the adjudication engine 202 can be implemented in a variety of ways in accordance with different embodiments of the disclosure. A language model is a type of machine learning model that is trained to conduct a probability distribution over words. Language models may include, for example, statistical models and those based on deep neural networks, e.g., neural language models. Statistical language models are a type of model that use statistical patterns in the data to make predictions about the likelihood of specific sequences of words. One approach to building a probabilistic language model is to calculate n-gram probabilities. An n-gram is a sequence of words, where n is a number greater than zero. To make a simple probabilistic language model, the likelihood of different n-grams, i.e., word combinations, in a portion of text is calculated. This may be done by counting the number of times each word combination appears and dividing it by the number of times the previous word appears. This approach is based on a concept called Markov assumption, which says that the probability of the next word in a sequence depends only on a fixed size window of previous words.

Neural language models predict the likelihood of a sequence of words using a neural network model. Neural language models may capture context better than traditional statistical models. Neural language models may also handle more complex language structure and longer dependencies between words. The neural network model may be trained using a large training set of text data and are generally capable of learning the underlying structure of the language. Recurrent Neural Networks (RNNs) are a type of neural network that can memorize the previous outputs when receiving the next inputs. This is in contrast to traditional neural networks, where inputs and outputs are independent of each other. RNNs may be particularly useful when it is necessary to predict the next word in a sentence, as they can take into account the previous words in the sentence. RNNs, however, can be computationally expensive and may not scale well to very long input sequences.

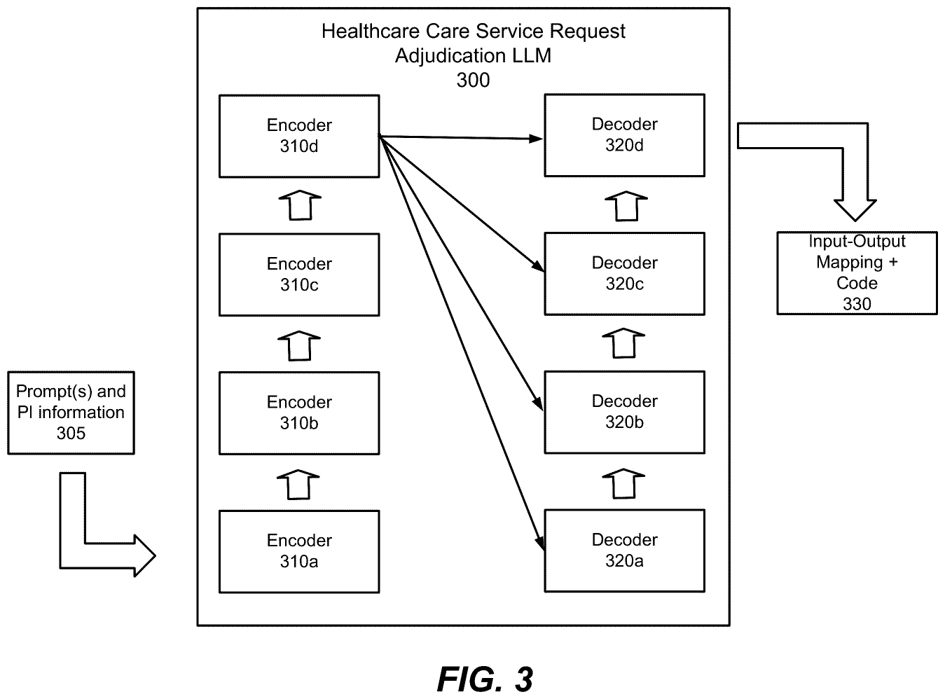

A large language model is a language model that is characterized by its large size, which is enabled by AI hardware accelerators allowing the model to process vast amounts of data. A large language model may be based on a neural network, which can contain a large number of weights and may be pre-trained using self-supervised and/or semi-supervised learning. In some embodiments, the large language model may be based on a transformer architecture. FIG. 3 is a block diagram of a healthcare care service request adjudication large language model 300 in accordance with embodiments of the disclosure, which is based on a transformer architecture. The transformer name is based on the ability of the architecture to transform one sequence into another. Moreover, the transformer architecture provides for the ability to process an entire word sequence at once as opposed to one step at a time, such as is one in RNNs. This parallelization allows large language models based on a transformer architecture to be faster to train and operate in inference mode thereby improving the performance of a computer system. As shown in FIG. 3, the appeal adjudication large language model uses an encoder-decoder architecture. An encoder stack 310a, . . . , 310d may receive a sequence of input data, which may include one or more prompts and PI information 305 from a PI document, for example, and convert this information into vectors, which represent the semantics and position of the words in the sentences. The decoder stack 320a, . . . , 320d may receive this vector embedding of the prompt(s) and PI information 305 and use them to generate context and product the input-output mappings and the code 330. In some embodiments, both the encoder and decoder include a stack of identical layers 310a, . . . , 310d and 320a, . . . , 320d, respectively, each containing a self-attention mechanism and a feed-forward neural network. The attention mechanism may allow the healthcare care service request adjudication large language model 300 to focus on specific parts of the prompt(s) and PI information 305 when making predictions. Specifically, may calculate a weight for each element of the input, which indicates the importance of that element for the current prediction. These weights may then then used to calculate a weighted sum of the input, which is used to generate the prediction. Self-attention is a specific type of attention mechanism where the healthcare care service request adjudication large language model 300 focuses on different parts of the input sequence to make a prediction. In such embodiments, the healthcare care service request adjudication large language model 300 looks at the input sequence multiple times while focusing on a different part of the input sequence each time it looks at it. The transformer architecture may allow the self-attention mechanism to be applied multiple times in parallel, which may allow the healthcare care service request adjudication large language model 300 to learn more complex relationships between the prompts and PI information 305 and the input-output mappings and code 330.

The healthcare care service request adjudication large language model 300 may be trained using semi-supervised learning in some embodiments of the disclosure. The healthcare care service request adjudication large language model 300 may be pre-trained using a large dataset of unlabeled data in an unsupervised training operation. The initial pre-training may allow the healthcare care service request adjudication large language model 300 to learn general patterns and relationships in the language. A second supervised training operation may then be performed in which the model may be trained using a smaller labeled dataset, such as, for example, PI information from PI documents associated with various payors. This second supervised training operation may improve the performance of the healthcare care service request adjudication large language model 300 for specific applications, such as appeals of health care claims.

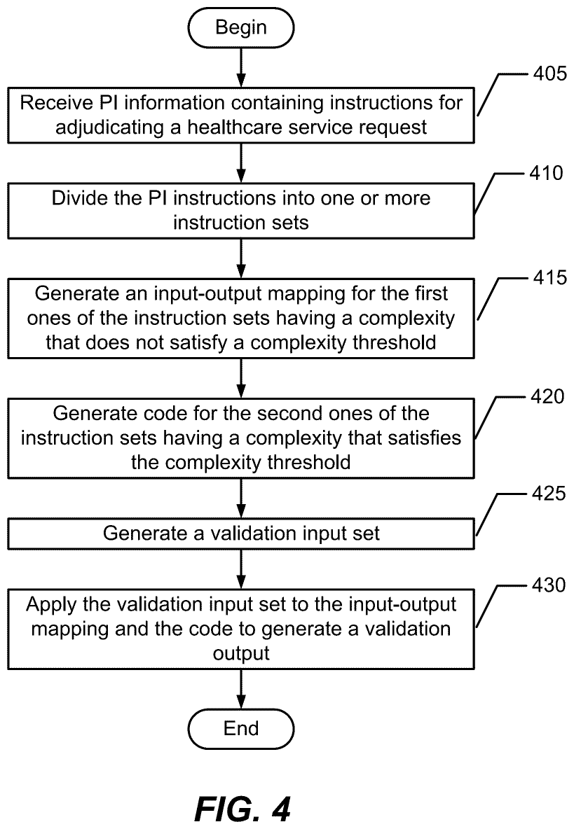

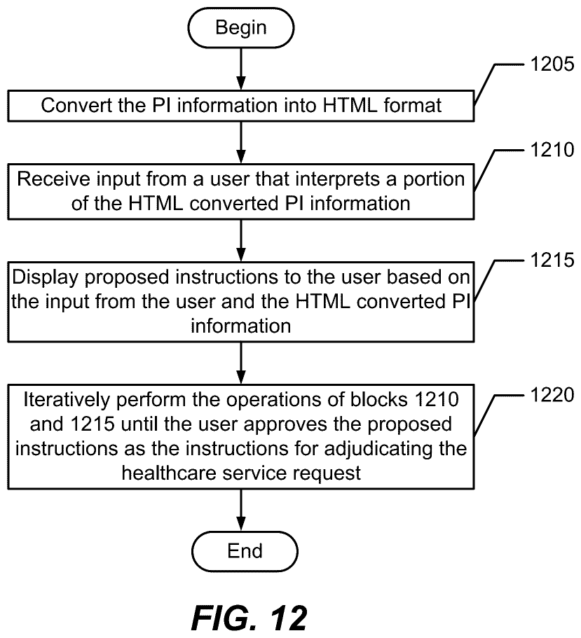

FIG. 4 is a flowchart that illustrates operations of the AI assisted decision support system for adjudicating health care claim appeals in accordance with some embodiments of the disclosure. Referring now to FIG. 4, operations begin at block 405 in which the healthcare care service request adjudication large language model 300 receives PI information containing instructions for adjudicating a healthcare service request of a decision. In some embodiments, a determination may be made whether this PI information is a new or a modified version of previous PI information processed by the healthcare care service request adjudication large language model 300. In some embodiments, the PI information can be generated by applying an intelligent parser and/or a language model to documented Standard Operating Procedures (SOP). Further, subject matter experts and/or a trained AI based subject matter expert on the standard operating procedures be applied to the PI information to provide feedback for refining the PI information 218 (e.g., correct errors, provide additional detail, and the like) before the appeal adjudication large language model is used to generate the input-output mappings and code, including API calls and/or API references, based on the PI information. For example, in some embodiments of the disclosure illustrated in the flowchart of FIG. 12, operations begin at block 1205 where the PI information is converted into Hypertext Markup Language (HTML) format. At block 1210, a user, such as a subject matter expert, may provide input that assists in interpreting a portion of the HTML converted PI information. In some embodiments, this input may be provided in XPath format. The healthcare care service request adjudication large language model 300 may display proposed instructions to the user based on the input from the user and the HTML converted PI information at block 1215. The operations of blocks 1210 and 1215 may be iteratively performed until the user approves the proposed instructions as the instructions from the SOP document, for example, for use in adjudicating the healthcare service request at block 1220.

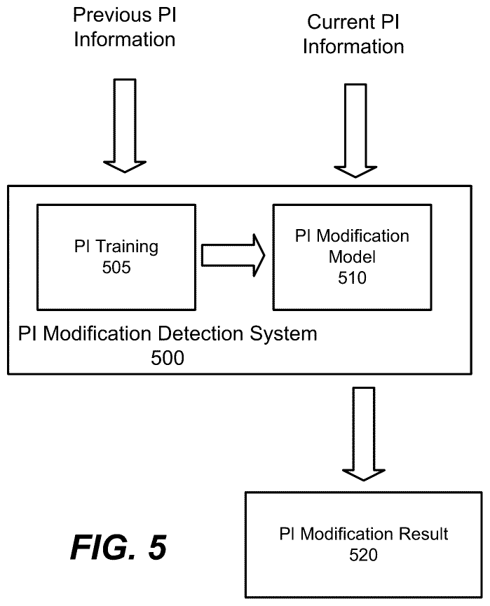

FIG. 5 is a block diagram that illustrates embodiments of an AI based PI modification detection system 500 in which an AI engine is used to process current PI information, such as a PI document associated with a payor, to determine whether the PI information is new, a modified version of previous PI information processed by the healthcare care service request adjudication large language model 300, or if the PI information is the same PI information that has been previously processed. The PI modification detection system 500 may include a PI training module 505 and PI modification model 510. The PI training module 505 may be configured to receive previous PI information, such as previous PI documents for one or more payors that have been processed using the healthcare care service request adjudication large language model 300. During training, the PI training module 505 may learn associations between features of the content contained in the previous PI information, e.g., previous PI documents. Once the PI training module 505 is trained, a PI modification model 510 may be generated to operate in prediction model The PI modification model 510 may be configured to receive the current PI information and output a PI modification result 520, which indicates whether the current PI information is new, is a modified version of previous PI information processed by the healthcare care service request adjudication large language model 300, or is the same as previous PI information processed by the healthcare care service request adjudication large language model 300. In some embodiments, the PI modification model 510 may identify the specific portions of the current PI information that are modified relative to previous PI information processed by the healthcare care service request adjudication large language model 300, which may reduce the amount of input-output mapping and/or code that needs to be generated to replicate the instructions of the current PI information.

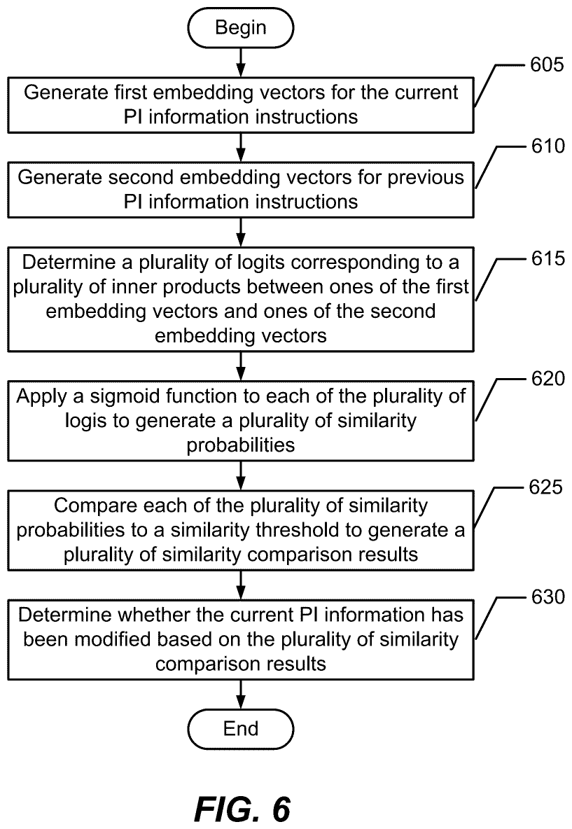

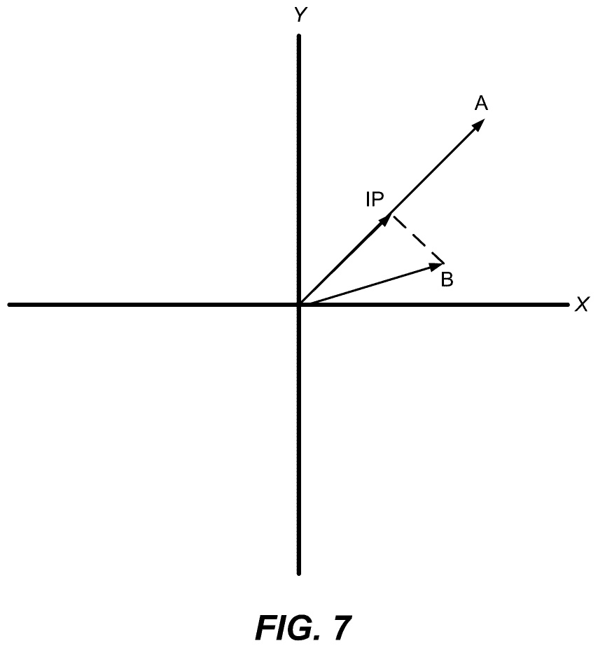

FIG. 6 is a flowchart that illustrates operations of the PI modification model 510 for determining whether current PI information is new, is a modified version of previous PI information, or is the same as previous PI information. Operations begin at block 605 where first embedding vectors are generated for the current PI information instructions. At block 610, second embedding vectors are generated for previous PI information instructions. One technique for determining the similarity is to determine logits that correspond to the inner products (e.g., dot products) between ones of the first embedding vectors and ones of the second embedding vectors at block 615. The inner product between two two-dimensional vectors is illustrated, for example, in FIG. 7. As shown in FIG. 7 the inner product IP between two vectors A and B may be represented as a projection of the vector B onto the vector A. Note that the inner product could be negative depending on the orientation of the two vectors. Returning to FIG. 6, a sigmoid function may be applied to each of the plurality of logits at block 620 to normalize the logits and generate a plurality of similarity probabilities. Each of the similarity probabilities may be compared to a similarity threshold to generate a plurality of similarity comparison results at block 625. A prediction of whether the current PI information is new, modified, or is the same as previous PI information is generated at block 630 based on the plurality of similarity comparison results.

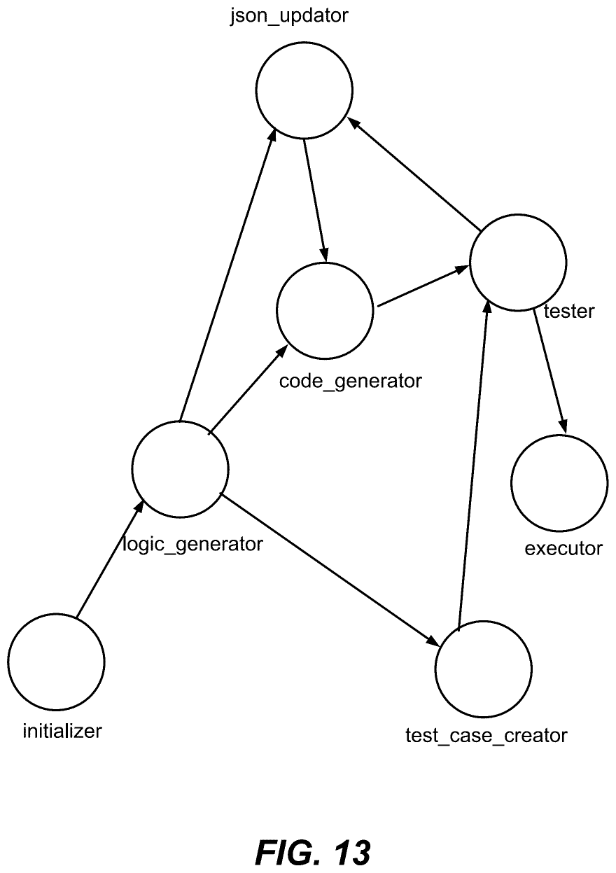

Returning to FIG. 4, the healthcare care service request adjudication large language model 300 divides the instructions contained in the PI information into one or more instruction sets at block 410. The healthcare care service request adjudication large language model 300 automatically generates an input-output mapping for first ones of the instruction sets having a complexity that does not satisfy a complexity threshold at block 415 and generates code for the second ones of the instruction sets having a complexity that satisfies the complexity threshold at block 420. By generating input-output mappings for less complex PI instructions and generating code for more complex PI instructions, the effective execution of the PI instructions on a computer can be performed more efficiently as code is generally more processor resource intensive than the input-output mappings. In some embodiments, the healthcare care service request adjudication large language model 300 may use natural language processing (NLP) to identify grammar elements and parts of speech in the PI instruction sentences to evaluate the complexity of the PI instructions. In some embodiments of the disclosure, the healthcare care service request adjudication large language model 300 may generate code for the second ones of the instruction sets having a complexity that satisfies the complexity threshold by using an agentic workflow. The agentic workflow may advantageously eliminate the need for developers to extract data from a source system, expose the data via an API for a large language model to consume the data. An agentic workflow refers to a more iterative and multi-step approach to using a large language model and AI agents to perform tasks as opposed to a non-agent approach of providing a prompt and receiving a single, direct response. As shown in FIG. 13, multiple agents may be used to generate code, such as python code to implement the PI instructions. The agents may use a document that is defined, which provides details for how to read the required information from the PI instructions. Referring to FIG. 13, seven agents are shown for generating the code to implement the PI instructions. An initializer agent may be configured to facilitate communication among the agents. A logic_generator agent may be configured to extract the logic from the PI instructions. A code_generator agent may be configured to develop code, such as python code, based on the output from the logic_generator. A test_case_creator agent may be configured to develop unit test code based on the output from the logic extractor. A tester agent may be configured to validate the code generated by the code_generator agent using the unit test code generated by the test_case_creator agent. The executor agent may be configured for use by the tester agent to execute the generated code and unit tests cases. Errors or defects determined from the unit test cases may be provided as feedback via the json_updator agent and the code_generator agent may be configured to fix the identified defect. The operations of the code_generator agent, test_case_creator agent, tester agent, executor agent, and json_updator agent may be repeated until the code is error free, meets a satisfactory error rate, and/or a defined maximum number of iterations are performed.

As described above, an appeal request, claim, and any attachments may serve as a primary fact source, for adjudicating an appeal decision, but various secondary fact sources may be accessed to obtain other facts that are pertinent in adjudicating the appeal. In some embodiments, the healthcare care service request adjudication large language model 300 may insert API calls or references to APIs into the generated code that may be used to access these secondary fact sources to obtain the needed facts for adjudicating the appeal. In some embodiments, the reference to an API may be interpreted at run time and an API call generated to access the appropriate secondary fact source.

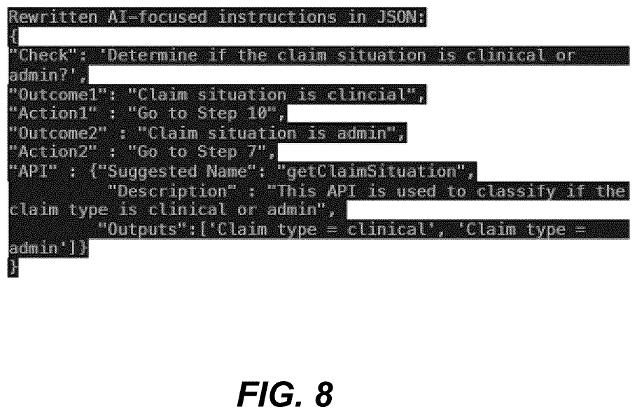

When processing the PI information, some operations in the PI instructions may be relatively complex and may be difficult for the healthcare care service request adjudication large language model 300 to extract the rules and logical flow. For such steps, more detailed prompts can be developed that organize the operations, decisions, and outputs from the PI information that are more readily understandable by the healthcare care service request adjudication large language model 300. FIG. 8 is an example of a prompt that may be used as an input to the healthcare care service request adjudication large language model 300 to generate the code from the PI information. In some embodiments, elements of the second ones of the instruction sets at block 420 of FIG. 4 are extracted and one or more prompts, such as the example in FIG. 8 are generated therefrom. These one or more prompts may then be used to generate code for implementing the PI instructions. In accordance with different embodiments of the disclosure, the structured format may be Hypertext Markup Language (HTML) or Javascript Object Notation (JSON), such as is used in the example of FIG. 8. Note that the JSON example of FIG. 8 includes reference to an API for accessing a secondary fact source, which is not available in an API library. As a result, the prompt includes a suggested name, description, and expected outputs for the API to be developed and accessed through the generated code.

Returning to FIG. 4, the healthcare care service request adjudication large language model 300 automatically generates a validation input set at block 425. In some embodiments, the validation input set includes all possible inputs for validating the each of the PI instructions as represented in the input-output mapping and the code. The validation input set is applied to the input-output mapping and the code at block 430 to ensure that the input-output mapping and the code accurately reflect the logic contained in the PI instructions. In some embodiments, the input-output mapping and the code may be applied to a curated or selected set of PI documents or information, which may have known outputs for defined inputs, and the results evaluated. By validating the accuracy of the input-output mapping and the code before the input-output mappings and code are used to adjudicate an appeal, the need to correct errors in the input-output mapping and/or code and adjudicate an appeal multiple times may be reduced thereby saving processor and other computing resources. The output of the validation operation of block 430 may be fed back to refine the generated input-output mapping and code.

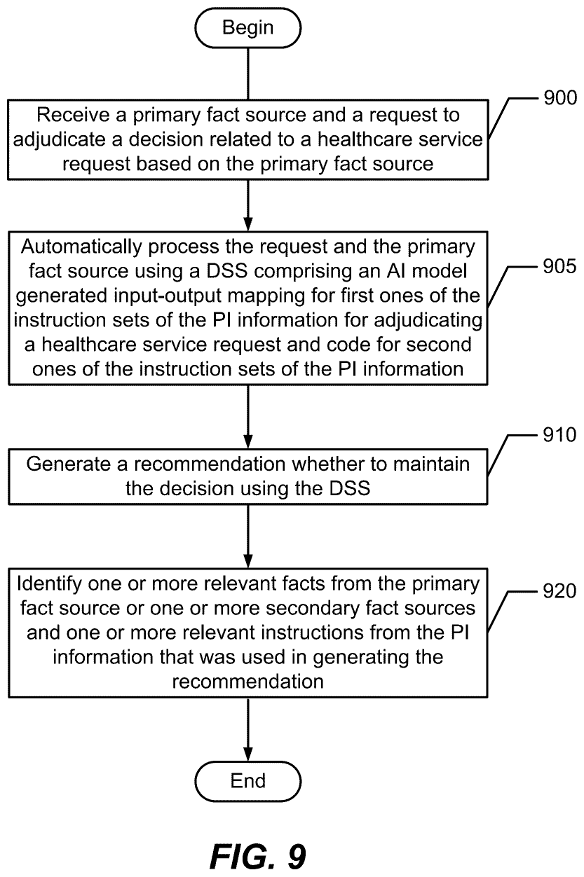

FIG. 9 is a flowchart that illustrates operations of the input-output mapping and code generated by the healthcare care service request adjudication large language model 300 in processing an appeal of a decision based on PI information that contains instructions for adjudicating the appeal in accordance with some embodiments of the disclosure. Referring now to FIG. 9, operations begin at block 900 where a primary fact source and a request to adjudicate a decision related to a healthcare service request based on the primary fact source are received. The primary fact source may be, for example, a health care claim denied by a payor. At block 905 the request and primary fact source are automatically processed using a decision support system that comprises an AI model (i.e., healthcare care service request adjudication large language model 300) generated input-output mapping for first ones of the instruction sets of the PI information for adjudicating the appeal and code for second ones of the instruction sets of the PI information. When generating the input-output mappings and the code, an interpreter may guide the sequence of execution for the input-output mappings and the code based on the logic contained in the PI instructions. The first and second ones of the instruction sets of the PI information are differentiated based on their complexity as described above. During execution, any input-output mapping and/or portion of code that requires input during runtime may not be cached, while other input-output mappings and/or portions of code may be cached for potential reuse. A recommendation of whether to maintain or reverse the decision is generated at block 910, which may be communicated to the appropriate authority for approval, or, in some instances, the recommendation may be automatically accepted. For example, a payor may automatically choose to accept the appeal decision recommendation for claims below a certain value threshold or when the recommendation is to approve payment of the claim. The healthcare care service request adjudication large language model 300 may identify one or more relevant facts from the primary fact source or one or more secondary fact sources and/or one or more relevant instructions from the PI information that was used in generating the recommendation at block 920. This may allow an auditor to manually review the PI information including the identified instruction(s) and facts to verify that the recommendation is based on sound reasoning and may provide a payor with more confidence that the PI instructions are correct, and they are being interpreted correctly by the healthcare care service request adjudication large language model 300 in the input-output mapping and code generation process. The accuracy of the input-output mappings and the code generated from the PI information may be evaluated based on the accuracy of the appeal recommendations. This information may be fed back to refine the language model used to generate the input-output mappings and the code.

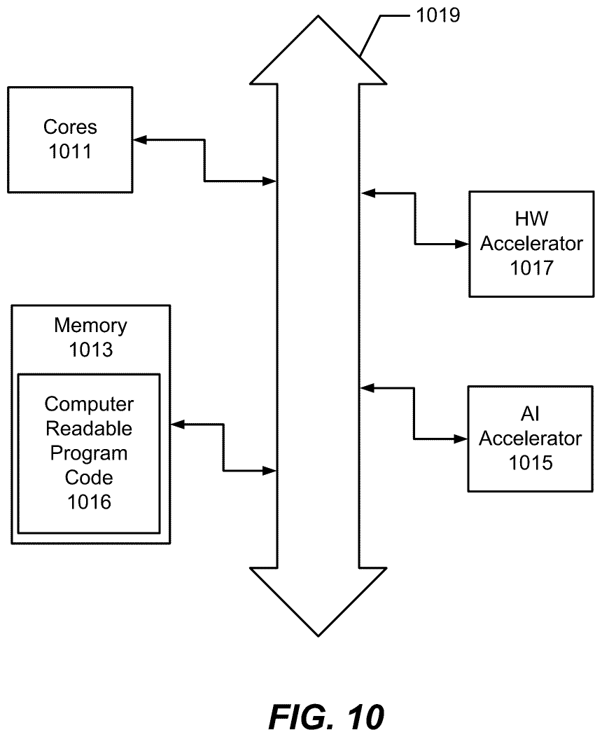

FIG. 10 is a block diagram of a data processing system that may be used to implement the healthcare care request adjudication assistant server 104 of FIG. 1, the adjudication engine 202 of FIG. 2, the healthcare care service request adjudication large language model 300 of FIG. 3, and the PI modification detection system 500 of FIG. 5. As shown in FIG. 10, the data processing system may include at least one core 1011, a memory 1013, an artificial intelligence (AI) accelerator 1015, and a hardware (HW) accelerator 1017. The at least one core 1011, the memory 1013, the AI accelerator 1015, and the HW accelerator 1017 may communicate with each other through a bus 1019.

The at least one core 1011 may be configured to execute computer program instructions. For example, the at least one core 1011 may execute an operating system and/or applications represented by the computer readable program code 1016 stored in the memory 1013. In some embodiments, the at least one core 1011 may be configured to instruct the AI accelerator 1015 and/or the HW accelerator 1017 to perform operations by executing the instructions and obtain results of the operations from the AI accelerator 1015 and/or the HW accelerator 1017. In some embodiments, the at least one core 1011 may be an Application Specific Instruction Set Processor (ASIP) customized for specific purposes and support a dedicated instruction set.

The memory 1013 may have an arbitrary structure configured to store data. For example, the memory 1013 may include a volatile memory device, such as dynamic random-access memory (DRAM) and static RAM (SRAM), or include a non-volatile memory device, such as flash memory and resistive RAM (RRAM). The at least one core 1011, the AI accelerator 1015, and the HW accelerator 1017 may store data in the memory 1013 or read data from the memory 1013 through the bus 1019.

The AI accelerator 1015 may refer to hardware designed for AI applications. In some embodiments, the AI accelerator 1015 may include a large language model and/or other AI models configured to facilitate operations associated with an AI assisted decision support system for adjudicating appeals of a decision as described above with respect to FIGS. 2-9. The AI accelerator 1015 may generate output data by processing input data provided from the at least one core 1015 and/or the HW accelerator 1017 and provide the output data to the at least one core 1011 and/or the HW accelerator 1017. In some embodiments, the AI accelerator 1015 may be programmable and be programmed by the at least one core 1011 and/or the HW accelerator 1017. The HW accelerator 1017 may include hardware designed to perform specific operations at high speed. The HW accelerator 1017 may be programmable and be programmed by the at least one core 1011.

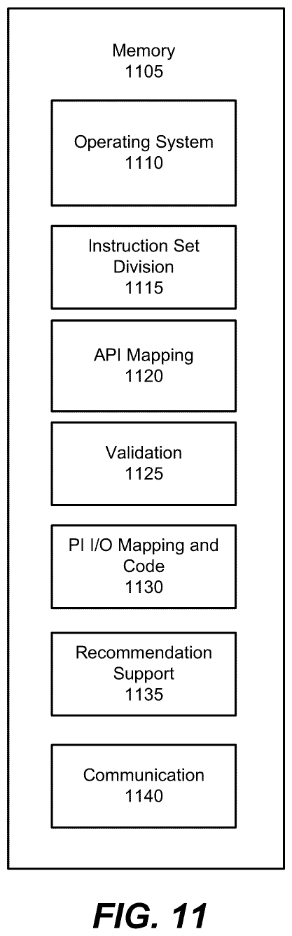

FIG. 11 illustrates a memory 1105 that may be used in embodiments of data processing systems, such as the healthcare care request adjudication assistant server 104 of FIG. 1, the adjudication engine 202 of FIG. 2, the healthcare care service request adjudication large language model 300 of FIG. 3, the PI modification detection system 500 of FIG. 5, and the data processing system of FIG. 10, respectively, to facilitate the adjudication of appeals of a decision using one or more AI models. The memory 1105 is representative of the one or more memory devices containing the software and data used for facilitating operations of the healthcare care request adjudication assistant server 104 of FIG. 1, the adjudication engine 202 of FIG. 2, the healthcare care service request adjudication large language model 300 of FIG. 3, and the PI modification detection system 500 of FIG. 5 as described herein. The memory 1105 may include, but is not limited to, the following types of devices: cache, ROM, PROM, EPROM, EEPROM, flash, SRAM, and DRAM. As shown in FIG. 11, the memory 1105 may contain seven or more categories of software and/or data: an operating system 1110, an instruction set division module 1115, an API mapping module 1120, a validation module 1125, a PI I/O mapping and code module 1130, a recommendation support module 1135, and a communication module 1140.

In particular, the operating system 1110 may manage the data processing system's software and/or hardware resources and may coordinate execution of programs by the processor. The instruction set division module 1115 may be configured to receive a PI document and divide the PI document into various components, such as the instruction sets, e.g., rules, the identities of internal and external systems that are accessed to obtain facts, any links to other process instructions, and outcomes based on the various instructions and facts, and to perform one or more operations described above with respect to the flowchart of FIG. 4. The API mapping module 1120 may be configured to insert API calls or references to APIs into the generated code that may be used to access secondary fact sources to obtain the needed facts for adjudicating an appeal and to perform one or more operations described above with respect to the flowchart of FIG. 4. The validation module 1125 may be configured to generate a validation input set that includes all possible inputs for validating the each of the PI instructions as represented in the input-output mapping and the code and to apply the validation input set to the input-output mapping and the code to ensure that the input-output mapping and the code accurately reflect the logic contained in the PI instructions. The validation module 1125 may be further configured to perform one or more of the operations of the flowchart of FIG. 4. The PI I/O mapping and code module 1130 may be configured to generate and execute the input-output mappings and the code as described above with respect to FIGS. 1-9. The recommendation support module 1135 may be configured to identify one or more relevant facts from a primary fact source or one or more secondary fact sources and/or one or more relevant instructions from the PI information that was used in generating a recommendation for an appeal and to perform one or more operations described above with respect to the flowchart of FIGS. 4 and 9. The communication module 1140 may be configured to facilitate communication between the healthcare care request adjudication assistant server 104 and an entity, such as a patient or member 102, health care provider 110, payor 160a, 160b, and/or secondary fact source 130a, . . . , 130n.

Although FIG. 11 illustrates hardware/software architectures that may be used in data processing systems, such as the healthcare care request adjudication assistant server 104 of FIG. 1 and the data processing system of FIG. 10, respectively, in accordance with some embodiments of the disclosure, it will be understood that embodiments of the present disclosure are not limited to such a configuration but is intended to encompass any configuration capable of carrying out operations described herein.

Computer program code for carrying out operations of data processing systems discussed above with respect to FIGS. 1-11 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality of the healthcare care request adjudication assistant server 104 and the data processing system of FIG. 10 may each be implemented as a single processor system, a multi-processor system, a multi-core processor system, or even a network of stand-alone computer systems, in accordance with various embodiments of the disclosure. Each of these processor/computer systems may be referred to as a “processor” or “data processing system.” The functionality provided by the healthcare care request adjudication assistant server 104 may be embodied as a single server or embodied as separate servers in accordance with different embodiments of the disclosure.

The data processing apparatus described herein with respect to FIGS. 1-10 may be used to facilitate the adjudication of appeals of decisions, such as a denial of a health care claim by a payor, using one or more AI models according to some embodiments of the disclosure described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 1013 and memory 1105 when coupled to a processor includes computer readable program code that, when executed by the processor, causes the processor to perform operations including one or more of the operations described herein with respect to FIGS. 1-9.

Some of the embodiments of the disclosure may provide an AI assisted decision support system that may be used generally to adjudicate a decision based on a primary fact source, such as an appeal or other type of healthcare care request decision. In particular embodiments, the decision may be an appeal of a health care claim that has been denied in whole or in part by a payor. The AI assisted decision support system may include an appeal adjudication large language model that may automatically generate input-output mappings or code based on the complexity of the instructions obtained from a PI document that outline the adjudication process for the appeal. These input-output mappings and code may be executable on a computer to automate the application of the PI instructions to the facts surrounding the appeal. The claim and any attachments may serve as a primary fact source, but various secondary fact sources may be accessed to obtain other facts that are pertinent in adjudicating the appeal. The healthcare care service request adjudication large language model may insert API calls or references to APIs into the generated code that may be used to access these secondary fact sources to obtain the needed facts for adjudicating a decision, such as an appeal. The healthcare care service request adjudication large language model may generate a validation input set that includes all possible inputs for validating the each of the PI instructions as represented in the input-output mapping and the code. The validation input set can be applied to the input-output mapping and the code to ensure that the input-output mapping and the code accurately reflect the logic contained in the PI instructions. When the input-output mapping and code are executed to generate a recommendation on whether to maintain a denial of a claim or to overturn the denial and sustain the appeal, the healthcare care service request adjudication large language model may identify one or more of the PI instructions and/or one or more facts used in making the recommendation that had the most significant impacts in reaching the recommendation.

Some embodiments of the disclosure may provide an AI assisted decision support system as set forth by the following examples: Example 1: a computer-implemented method, comprises: receiving, by one or more processors, Process Instruction (PI) information containing instructions for adjudicating a healthcare service request based on a primary fact source; dividing, by the one or more processors and using an Artificial Intelligence (AI) model, the instructions into one or more instruction sets; generating, by the one or more processors and the AI model, an input-output mapping for first ones of the one or more instruction sets having a complexity that does not satisfy a complexity threshold; generating, by the one or more processors and the AI model, code for second ones of the one or more instructions sets having the complexity that satisfies the complexity threshold; generating, by the one or more processors and the AI model, a validation input set for the input-output mapping and for the code; and applying, by the one or more processors and the AI model, the validation input set to the input-output mapping and the code to generate a validation output for the input-output mapping and for the code.
Example 2: the computer-implemented method of Example 1, the method further comprising: when the one or more instruction sets reference access to one or more facts not included in the primary fact source, selecting, by the one or more processors and the AI model, one or more Application Programming Interfaces (APIs) for one or more secondary fact sources from an API library for accessing the one or more facts; and inserting, by the one or more processors and the AI model, the selected one or more APIs as API calls into the code.
Example 3: the computer-implemented method according to any of Examples 1 and 2, the method further comprising: when the one or more instruction sets reference access to one or more facts not included in the primary fact source and an Application Programming Interface (API) for a secondary fact source for accessing the one or more facts does not exist in an API library, generating, by the one or more processors and the AI model, an API for the secondary fact source for accessing the one or more facts, the API for the secondary fact source including an API description, inputs to the API, and expected outputs from the API.
Example 4: the computer-implemented method according to any of Examples 1-3, wherein generating the code comprises: extracting, by the one or more processors and the AI model, elements of the second ones of the one or more instructions sets into a structured format; generating, by the one or more processors and the AI model, one or more prompts from the elements in the structured format; and generating, by the one or more processors and the AI model, code for the second ones of the one or more instructions sets based on the one or more prompts.
Example 5: the computer-implemented method of Example 4, wherein the structured format is Hypertext Markup Language (HTML) or Javascript Object Notation (JSON).
Example 6: the computer-implemented method according to any of Examples 1-5, wherein the PI information is current PI information, and the AI model is a first AI model, the method further comprising: determining, by the one or more processors and a second AI model, whether the current PI information has been modified relative to previous PI information; and when the current PI information has been modified, performing, by the one or more processors and the first AI model, dividing the instructions, generating the input-output mapping, generating the code, generating the validation input set, and applying the validation input set.
Example 7: the computer-implemented method according to Example 6, wherein determining, by the one or more processors and the second AI model, whether the current PI information has been modified comprises: generating, by the one or more processors and the second AI model, first embedding vectors for the current PI information instructions; generating, by the one or more processors and the second AI model, second embedding vectors for previous PI information instructions; and determining, by the one or more processors and the second AI model, similarities between the first embedding vectors and the second embedding vectors.
Example 8: the computer-implemented method according to Example 7, wherein determining the similarities comprises: determining, by the one or more processors and the second AI model, a set of logits corresponding to a set of inner products between ones of the first embedding vectors and ones of the second embedding vectors.
Example 9: the computer-implemented according to Example 8, wherein determining the similarities further comprises: applying, by the one or more processors and the second AI model, a sigmoid function to each of the set of logits to generate a set of similarity probabilities.
Example 10, the computer-implemented method of Example 9, determining whether the current PI information has been modified comprises: comparing, by the one or more processors and the second AI model, each of the set of similarity probabilities to a similarity threshold to generate a set of similarity comparison results; and determining, by the one or more processors and the second AI model, whether the current PI information has been modified based on the set of similarity comparison results.
Example 11: the computer-implemented method according to any of Examples 1-10, wherein the complexity is based on grammar elements in sentences of the PI information instructions.
Example 12: the computer-implemented method according to any of Examples 1-11, wherein the primary fact source is a health insurance claim, the decision is a denial of payment of the health insurance claim by a payor, and the PI information is associated with the payor.
Example 13: the computer-implemented method according to any of Examples 1-12, wherein the AI model is a large language model.
Example 14: the computer implemented method according to any of examples 1-13, wherein receiving, the PI information containing instructions for adjudicating the healthcare service request based on the primary fact source comprises: converting, by the one or more processors, the PI information into Hypertext Markup Language (HTML) format; receiving, by the one or more processors, input from a user that interprets a portion of the HTML converted PI information; displaying, by the one or more processors and the AI model, proposed instructions to the user based on the input from the user and the HTML converted PI information; and iteratively performing, by the one or more processors and the AI model, the receiving input from the user and displaying the proposed instructions to the user until receiving approval from the user of the proposed instructions as the instructions for adjudicating the healthcare service request.
Example 15: the computer implemented method according to any of examples 1-14, wherein generating the code for the second ones of the one or more instructions sets having the complexity that satisfies the complexity threshold, comprises: generating, by the one or more processors and the AI model, the code for the second ones of the one or more instructions sets having the complexity that satisfies the complexity threshold using an agentic workflow.
Example 16: a computer-implemented method, comprises: receiving, by one or more processors, a primary fact source and a request to adjudicate a decision related to a healthcare service request based on the primary fact source; automatically processing, by the one or more processors, the request and the primary fact source using a Decision Support System (DSS), the DSS comprising an Artificial Intelligence (AI) model generated input-output mapping for first ones of one or more instructions sets of Process Instruction (PI) information for adjudicating the decision and code for second ones of the one or more instruction sets of the PI information, the code including one or more Application Programming Interface (API) calls to one or more secondary fact sources for accessing one or more facts not included in the primary fact source; generating, by the one or more processors and the DSS, a recommendation whether to maintain the decision; and identifying, by the one or more processors and the AI model, one or more relevant facts from the primary fact source or the one or more secondary fact sources and one or more relevant instructions from the PI information instruction sets used in generating the recommendation.
Example 17: the computer-implemented method according to Example 16, wherein automatically processing the request and the primary fact source comprises: selecting, by the one or more processors, the input-output mapping or the code for performing the processing one or more portions of the request or the primary fact source based on the request and the primary fact source.
Example 18: the computer-implemented method according to any of Examples 16-17, wherein the primary fact source is a health insurance claim, the decision is a denial of payment of the health insurance claim by a payor, and the PI information is associated with the payor.
Example 19: the computer-implemented method according to any of Examples 16-18, wherein the AI model is a large language model.
Example 20: a system, comprises one or more processors; and at least one memory storing computer readable program code that is executable by the one or more processors to perform operations comprising: receiving Process Instruction (PI) information containing instructions for adjudicating a healthcare service request based on a primary fact source; dividing, by an Artificial Intelligence (AI) model, the instructions into one or more instruction sets; generating, by the AI model, an input-output mapping for first ones of the one or more instruction sets having a complexity that does not satisfy a complexity threshold; generating, by the AI model, code for second ones of the one or more instructions sets having the complexity that satisfies the complexity threshold; generating, by the AI model, a validation input set for the input-output mapping and for the code; and applying, by the AI model, the validation input set to the input-output mapping and the code to generate a validation output for the input-output mapping and for the code.
Example 21: the system according to Example 20, wherein the operations further comprise: when the one or more instruction sets reference access to one or more facts not included in the primary fact source, selecting, by the AI model, one or more Application Programming Interfaces (APIs) for one or more secondary fact sources from an API library for accessing the one or more facts; and inserting, by the AI model, the selected one or more APIs as API calls into the code.
Example 22: one or more non-transitory computer readable storage media comprising computer readable program code stored in the media that is executable by one or more processors to perform operations comprising: receiving Process Instruction (PI) information containing instructions for adjudicating a healthcare service request based on a primary fact source; dividing, by an Artificial Intelligence (AI) model, the instructions into one or more instruction sets; generating, by the AI model, an input-output mapping for first ones of the one or more instruction sets having a complexity that does not satisfy a complexity threshold; generating, by the AI model, code for second ones of the one or more instructions sets having the complexity that satisfies the complexity threshold; generating, by the AI model, a validation input set for the input-output mapping and for the code; and applying, by the AI model, the validation input set to the input-output mapping and the code to generate a validation output for the input-output mapping and for the code.
Example 23: a computer-implemented method comprising: receiving, by one or more processors via a first machine learning model, a prompt configured to instruct the first machine learning model to parse text input into the first machine learning model; determining, by the one or more processors via the first machine learning model, that at least a portion of the parsed text input maps to an application programming interface (API) among a set of APIs identified by a second machine learning model; generating, by the one or more processors via the first machine learning model, a response message based on the prompt and the API; and establishing, by the one or more processors and based on the generated response message, a communication session with a data source via the API.
Example 24: the computer-implemented method according to any of Examples 1-15, further comprising: training, by the one or more processors, the AI model using historical PI information.
Example 25, the computer-implemented method according to any of Examples 1-15, wherein the one or more processors are included in a first computing entity; and wherein the method further comprises: training, by one or more processors included in a second computing entity, the AI model using historical PI information.
Example 26: the computer-implemented method according to any of Examples 16-19, further comprising: training, by the one or more processors, the AI model using historical PI information.
Example 27, the computer-implemented method according to any of Examples 16-19, wherein the one or more processors are included in a first computing entity; and wherein the method further comprises: training, by one or more processors included in a second computing entity, the AI model using historical PI information.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

The embodiments of the present disclosure have been presented for purposes of illustration and description, but are not intended to be exhaustive or limited to the disclosure in the form disclosed. Many modifications and variations may be apparent to those of ordinary skill in the art without departing from the scope and spirit of the disclosure. The aspects of the disclosure herein were chosen and described to best explain the principles of the disclosure and the practical application thereof, and to enable others of ordinary skill in the art to understand the disclosure with various modifications as are suited to the particular use contemplated.

1. A computer-implemented method, comprising:
receiving, by one or more processors, Process Instruction (PI) information containing instructions for adjudicating a healthcare service request based on a primary fact source;
dividing, by the one or more processors and using an Artificial Intelligence (AI) model, the instructions into one or more instruction sets;
generating, by the one or more processors and the AI model, an input-output mapping for first ones of the one or more instruction sets having a complexity that does not satisfy a complexity threshold;
generating, by the one or more processors and the AI model, code for second ones of the one or more instructions sets having the complexity that satisfies the complexity threshold;
generating, by the one or more processors and the AI model, a validation input set for the input-output mapping and for the code; and
applying, by the one or more processors and the AI model, the validation input set to the input-output mapping and the code to generate a validation output for the input-output mapping and for the code.

2. The computer-implemented method of claim 1, the method further comprising:
when the one or more instruction sets reference access to one or more facts not included in the primary fact source, selecting, by the one or more processors and the AI model, one or more Application Programming Interfaces (APIs) for one or more secondary fact sources from an API library for accessing the one or more facts; and
inserting, by the one or more processors and the AI model, the selected one or more APIs as API calls into the code.

3. The computer-implemented method of claim 1, the method further comprising:
when the one or more instruction sets reference access to one or more facts not included in the primary fact source and an Application Programming Interface (API) for a secondary fact source for accessing the one or more facts does not exist in an API library, generating, by the one or more processors and the AI model, an API for the secondary fact source for accessing the one or more facts, the API for the secondary fact source including an API description, inputs to the API, and expected outputs from the API.

4. The computer-implemented method of claim 1, wherein generating the code comprises:
extracting, by the one or more processors and the AI model, elements of the second ones of the one or more instructions sets into a structured format;
generating, by the one or more processors and the AI model, one or more prompts from the elements in the structured format; and
generating, by the one or more processors and the AI model, code for the second ones of the one or more instructions sets based on the one or more prompts.

5. The computer-implemented method of claim 4, wherein the structured format is Hypertext Markup Language (HTML) or Javascript Object Notation (JSON).

6. The computer-implemented method of claim 1, wherein the PI information is current PI information, and the AI model is a first AI model, the method further comprising:
determining, by the one or more processors and a second AI model, whether the current PI information has been modified relative to previous PI information; and
when the current PI information has been modified, performing, by the one or more processors and the first AI model, dividing the instructions, generating the input-output mapping, generating the code, generating the validation input set, and applying the validation input set.

7. The computer-implemented method of claim 6, wherein determining,
by the one or more processors and the second AI model, whether the current PI information has been modified comprises:
generating, by the one or more processors and the second AI model, first embedding vectors for the current PI information instructions;
generating, by the one or more processors and the second AI model, second embedding vectors for previous PI information instructions; and
determining, by the one or more processors and the second AI model, similarities between the first embedding vectors and the second embedding vectors.

8. The computer-implemented method of claim 7, wherein determining the similarities comprises:
determining, by the one or more processors and the second AI model, a set of logits corresponding to a set of inner products between ones of the first embedding vectors and ones of the second embedding vectors.

9. The computer-implemented method of claim 8, wherein determining the similarities further comprises:
applying, by the one or more processors and the second AI model, a sigmoid function to each of the set of logits to generate a set of similarity probabilities.

10. The computer-implemented method of claim 9, wherein determining whether the current PI information has been modified comprises:
comparing, by the one or more processors and the second AI model, each of the set of similarity probabilities to a similarity threshold to generate a set of similarity comparison results; and
determining, by the one or more processors and the second AI model, whether the current PI information has been modified based on the set of similarity comparison results.

11. The computer-implemented method of claim 1, wherein the complexity is based on grammar elements in sentences of the PI information instructions.

12. The computer-implemented method of claim 1, wherein the primary fact source is a health insurance claim, the decision is a denial of payment of the health insurance claim by a payor, and the PI information is associated with the payor.

13. The computer-implemented method of claim 1, wherein the AI model is a large language model.

14. The computer-implemented method of claim 1, wherein receiving, the PI information containing instructions for adjudicating the healthcare service request based on the primary fact source comprises:
converting, by the one or more processors, the PI information into Hypertext Markup Language (HTML) format;
receiving, by the one or more processors, input from a user that interprets a portion of the HTML converted PI information;
displaying, by the one or more processors and the AI model, proposed instructions to the user based on the input from the user and the HTML converted PI information; and
iteratively performing, by the one or more processors and the AI model, the receiving input from the user and displaying the proposed instructions to the user until receiving approval from the user of the proposed instructions as the instructions for adjudicating the healthcare service request.

15. The computer-implemented method of claim 1, wherein generating the code for the second ones of the one or more instructions sets having the complexity that satisfies the complexity threshold, comprises:
generating, by the one or more processors and the AI model, the code for the second ones of the one or more instructions sets having the complexity that satisfies the complexity threshold using an agentic workflow.

16. A computer-implemented method, comprising:
receiving, by one or more processors, a primary fact source and a request to adjudicate a decision related to a healthcare service request based on the primary fact source;
automatically processing, by the one or more processors, the request and the primary fact source using a Decision Support System (DSS), the DSS comprising an Artificial Intelligence (AI) model generated input-output mapping for first ones of one or more instructions sets of Process Instruction (PI) information for adjudicating the decision and code for second ones of the one or more instruction sets of the PI information, the code including one or more Application Programming Interface (API) calls to one or more secondary fact sources for accessing one or more facts not included in the primary fact source;
generating, by the one or more processors and the DSS, a recommendation whether to maintain the decision; and
identifying, by the one or more processors and the AI model, one or more relevant facts from the primary fact source or the one or more secondary fact sources and one or more relevant instructions from the PI information instruction sets used in generating the recommendation.

17. The computer-implemented method of claim 16, wherein automatically processing the request and the primary fact source comprises:
selecting, by the one or more processors, the input-output mapping or the code for performing the processing one or more portions of the request or the primary fact source based on the request and the primary fact source.

18. The computer-implemented method of claim 16, wherein the primary fact source is a health insurance claim, the decision is a denial of payment of the health insurance claim by a payor, and the PI information is associated with the payor.

19. The computer-implemented method of claim 16, wherein the AI model is a large language model.

20. A system, comprising:
one or more processors; and
one or more memories storing process-executable instructions that, when executed by the one or more processors, cause the one or more processors to perform operations comprising:
receiving Process Instruction (PI) information containing instructions for adjudicating a healthcare service request based on a primary fact source;
dividing, by an Artificial Intelligence (AI) model, the instructions into one or more instruction sets;
generating, by the AI model, an input-output mapping for first ones of the one or more instruction sets having a complexity that does not satisfy a complexity threshold;
generating, by the AI model, code for second ones of the one or more instructions sets having the complexity that satisfies the complexity threshold;
generating, by the AI model, a validation input set for the input-output mapping and for the code; and
applying, by the AI model, the validation input set to the input-output mapping and the code to generate a validation output for the input-output mapping and for the code.

21-23. (canceled)
